(19) United States
(12) Patent Application Publication
(10) Pub. No.: US 2012/0116594 A1
(43) Pub. Date: May 10, 2012

(54) JET PUMP SYSTEM FOR HEAT AND COLD MANAGEMENT, APPARATUS, ARRANGEMENT AND METHODS OF USE

(76) Inventors: Zine Aidoun, Laval (CA); Mohamed Ouzzane, Anjou (CA)

(21) Appl. No.: 13/384,018

(22) PCT Filed: Jul. 13, 2010
(86) PCT No.: PCT/CA2010/001103

§ 371 Date: Jan. 13, 2012

(30) Foreign Application Priority Data
Jul. 13, 2009 (CA) 2671914

(51) Int. Cl. F25B 27/02; G05D 23/19; F25D 17/00; F25B 27/00; F25B 49/00

(52) U.S. Cl. 700/276; 62/467; 62/238.1; 62/235.1; 62/132; 62/118; 62/79

(57) ABSTRACT

A pumping system, method and computer readable medium for temperature management. The system comprises generator means for connection to an energy source, preferably waste heat or solar energy; condenser means; evaporator means; and pressure means comprising at least one supersonic ejector to receive and provide flow paths for input primary and secondary flows, the input primary flow being a gaseous or a liquid flow. The method comprises providing and operatively connecting energy source means, condenser means, evaporator means, generator means and a pressure means comprising at least one supersonic ejector to receive input primary and secondary flows from a flow path; selecting and delivering a supply of temperature management fluid to the flow path; and selectively adjusting the configuration and operational parameters of the ejectors in response to monitored temperature values and operating conditions. The system economically provides improved efficiency for heating, cooling or refrigeration.

### FIELD OF THE INVENTION

The present invention relates to pumping systems for temperature management, and in particular to refrigeration, cooling, heating and air conditioning using at least one supersonic ejector instead of, or in addition to, a conventional compressor. More particularly, the invention relates to a method, apparatus and system having improved efficiency over known systems, and in which the ejector is preferably powered by energy from waste heat, solar power, or from pressure variation during conversion from high to low pressure.

### BACKGROUND OF THE INVENTION

Mechanical compression machines, such as conventionally used for temperature management systems, i.e. heating, refrigeration, cooling and air conditioning, consume electricity (high quality energy) and leak important quantities of refrigerant responsible for greenhouse gas emissions to the environment. Mechanical compression is relatively complex and costly besides being subject to operational malfunction and costly repairs. These disadvantages have recently been compounded by significantly increased energy costs. Attempts have therefore been made to find alternative methods of providing effective, economical and environmentally acceptable temperature management.

Since waste heat is rejected in most energy conversion equipment, it is usually considered to be free, but because this waste heat is generally of low grade, it is difficult to produce useful work from it, so the waste energy is usually directly rejected to the environment.

However, waste heat use to drive refrigeration or heating systems is now considered to be very attractive. Recovered heat as a substitute for electrical power would have several benefits, including the advantages of using a no-cost or low-cost energy to create substantial savings, and replacing an energy source by waste energy to contribute to reduction of greenhouse gas emissions.

Systems are known in which low temperature waste streams can be recovered for cooling and heating, such as by tri-thermal machines such as solid and liquid sorption heat pumps, or ejectors. However, sorption technologies are complex, costly and cumbersome. Absorption machines, which are designed on a unit basis and assembled on site, can be applied in niche applications with high capacities, and are currently being proposed in smaller sizes for the commercial sector. However, due to their modest performance and high costs, they generally fail to compete with mechanical systems for cooling and refrigeration. Solid sorption machines are insufficiently developed and thus far have been found to be unreliable.

Ejector technology is simpler and less costly than competitive technologies relying on waste energy recovery, such as absorption, adsorption and chemical heat pump technologies. However, known ejectors have thus far only shown modest performance, and steam ejectors in particular have limited applications because of their low performances and their working conditions above freezing temperatures. Attempts to use steam ejectors with refrigerants have not shown much success.

Ejector operation relies on the principle of interaction between two fluid streams at different energy levels, in order to provide compression work. The stream with higher total energy is the primary stream or motive stream while the other, with the lower total energy, is the secondary or driven stream. As discussed further below, the mechanical energy transfer from the primary stream to the secondary stream imposes a compression effect on the secondary stream.

Conventional supersonic ejectors, having no moving parts, rely on turbulence. In such ejectors, the primary stream can be a liquid or a vapour, both streams being provided from a generator. Other ejectors are known which have internal moving parts, for example ejectors in the nature of turbines, which suffer from disadvantages in relation to their use in temperature management systems, including difficulty of manufacture and operation.

It would therefore be desirable to provide a temperature management system in which at least part of the compression is provided by an ejector which is powered at least in part by waste heat or other low or zero cost sources.

### SUMMARY OF THE INVENTION

It has now been found that improvements in the internal configuration, or geometry, of conventional static ejectors, together with addressing issues of fluid selection and cycle design, can result in sufficiently improved performance so as to justify their use in temperature management systems, and to take advantage of the fact that although, as discussed above, the overall efficiency of ejectors is generally lower than competitive technologies such as mechanical compression or absorption, they have the very valuable advantages of simplicity, low cost and low maintenance over these technologies, and the important unique advantage that they can use low temperature waste heat to operate.

It has further been found that for a large capacity system, it is advantageous to use multiple ejectors in the system. For systems where large load variations can be expected, the overall load can advantageously be distributed over small and medium capacity ejectors in a battery arrangement. Preferably, the characteristics and sizes of ejectors within a battery are not all the same, instead being set according to the particular end use application. This allows for the handling of load variations by simultaneously activating one or more ejectors by priority, based on particular ejector specifications, so as to maintain a maximum efficiency for a given condition.

Additionally, finer operational adjustments can be made in response to small fluctuations within an operating condition while a set of ejectors is activated. This is achieved by making internal adjustments to one or more of the ejectors, including relative positions of internal components, throttle control and flow bypassing strategy, throat section variation and similar measures.

The invention therefore seeks to provide a pumping system for temperature management comprising

(i) generator means, constructed and arranged to be operatively connected to an energy source;

(ii) condenser means;

(iii) evaporator means; and

(iv) pressure means comprising at least one supersonic ejector constructed and arranged to receive an input primary flow and an input secondary flow, the input primary flow being selected from a gaseous flow and a liquid flow.

The temperature management system is selected from at least one of heating, refrigeration and air-conditioning, and preferably the energy source is selected from at least one of a waste heat delivery means and a solar heat delivery means.

Optionally, the system further comprises separator means having an inlet means operatively connected to the pressure means and an outlet means operatively connected to the evaporator means; and the separator means can include a second inlet means and a second outlet means each operatively connected to the condenser means.

Optionally, the system comprises a plurality of supersonic ejectors, which can be operationally located according to the intended end use and operational environment of the system, and can be located in series, in parallel, or some can be in series and some in parallel.

Where the system comprises a plurality of supersonic ejectors, preferably at least one has a configuration and a capacity which differs from a configuration and a capacity of at least one other of the supersonic ejectors.

Preferably, the system further comprises a control means to selectively activate and deactivate individual supersonic ejectors in response to determinations of operating conditions within the system.

Preferably, each ejector in the system further comprises internal adjustment means, and preferably the internal adjustment means comprises means for adjusting at least one parameter selected from the configuration and dimensions of the flow paths provided for each of the input primary flow and the input secondary flow.

The invention further seeks to provide a method of temperature management for a structure, the method comprising the steps of
(a) providing energy source means, condenser means and evaporator means, and generator means for operative connection to the energy source means, the condenser means and the evaporator means;
(b) selecting a pressure means comprising at least one supersonic ejector, each ejector having an internal configuration constructed and arranged to receive an input primary flow and an input secondary flow;
(c) providing an operative connection between the pressure means, the condenser means and the evaporator means to provide a flow path for a temperature management fluid;
(d) selecting a temperature management fluid and delivering a supply of the selected temperature management fluid to the flow path;
(e) providing an operative connection between the generator means and the energy source means and using energy from the energy source means to activate and operate the generator to move the supply of temperature management fluid along the flow path to selectively regulate temperatures at selected locations associated with the structure;
(f) selectively monitoring temperatures at the selected locations to obtain determined temperature values; and
(g) selectively adjusting the configuration and operational parameters of the pressure means in response to the determined temperature values and operating conditions.

Preferably, each of the at least one supersonic ejector comprises internal adjustment means, and the adjusting in step (g) further comprises operating the internal adjustment means to selectively adjust the internal configuration of selected ones of the at least one supersonic ejector.

Preferably, each of the at least one supersonic ejector is constructed and arranged to receive an input primary flow selected from a gaseous flow and a liquid flow.

Preferably, the method comprises selecting a plurality of supersonic ejectors, at least two of which are operationally located in series, or in parallel.

Preferably, where a plurality of supersonic ejectors is provided, at least one is selected to have a configuration and a capacity which differs from a configuration and a capacity of at least one other of the supersonic ejectors.

Preferably, where a plurality of supersonic ejectors is provided, the method further comprises providing a control means operatively connected to each of the plurality of supersonic ejectors, and comprises selectively activating and deactivating individual ones of the supersonic ejectors.

Where the temperature management fluid is a refrigerant, it is preferably selected from R-123, R-134a, R-152, R-717, R-245fa, R290, R600, carbon dioxide and trans-butene.

Preferably, the energy source means is constructed and arranged to deliver energy selected from at least one of waste heat and solar heat.

Preferably, the monitoring is performed in a manner selected from periodically and continuously.

Preferably, where a plurality of supersonic ejectors is provided, the method comprises adjusting a configuration of the flow path in relation to each supersonic ejector; and more preferably, also comprises adjusting operational parameters selected from at least one of a rate of supply of energy to the energy source means, and location and configuration of at least one of the condenser means, the evaporator means, and the generator means.

The invention further seeks to provide a computer readable medium having recorded thereon computer readable instructions for performing at least one step of the method of the invention.

Preferably, the invention seeks to provide a computer readable medium having recorded thereon computer readable instructions for selectively monitoring temperatures at the selected locations to obtain determined temperature values; and selectively adjusting the configuration and operational parameters of the pressure means in response to the determined temperature values and operating conditions.

Preferably, the invention seeks to provide a computer readable medium having recorded thereon computer readable instructions for selectively adjusting the internal configuration of selected ones of the at least one supersonic ejector.

Preferably, the invention seeks to provide a computer readable medium having recorded thereon computer readable instructions for selectively activating and deactivating individual ones of a plurality of supersonic ejectors.

Preferably, the invention seeks to provide a computer readable medium having recorded thereon computer readable instructions for adjusting a configuration of the flow path in relation to each supersonic ejector.

Preferably, the invention seeks to provide a computer readable medium having recorded thereon computer readable instructions for adjusting operational parameters selected from at least one of a rate of supply of energy to the energy source means, and location and configuration of at least one of the condenser means, the evaporator means, and the generator means.

On the basis of an industrial size system and relying on successful integration of simulation-experimental data, an ejector based system can be designed to use waste energy at the site, and thereby increase existing refrigeration or cooling capacity and performance by reducing the condenser temperature level. A single phase vapour-vapour ejector system can be used as a direct refrigeration system for harnessing such available waste energy from conventional heating system exhausts on the site.

The application ranges for the invention thus include HVAC, in particular refrigeration and cooling systems for industrial, commercial and institutional applications. In each case, the system loop typically comprises a low temperature vapour generator, condenser, evaporator and an ejector, together with the refrigerant, circulation means (pumps) and control accessories (ordinary and special valves, controls). The generator will be operatively connected to the exhaust of any hot process, such as a heating system or an industrial process, to receive and recover waste energy to generate high pressure refrigerant vapour as the motive (primary) fluid for the ejector.

In the case of a vapour-vapour system for refrigeration or cooling, the generator and the evaporator feed the condenser with vapour by means of the vapour-vapour ejector, and the liquid from the condenser is partly pumped back to the generator and partly expanded to feed the evaporator. Chilled refrigerant from the evaporator is circulated in the zone to be cooled or refrigerated. For operating a system in a heating mode, it can be set to recover condensation heat which is then circulated in heated zones.

Alternatively, configurations based on liquid-vapour ejectors either allow the recovery of expansion energy lost, in the case of an expansion ejector, when condensate at a high pressure state flows to lower pressure at the evaporator conditions, or, in the case of a condensing ejector, allow for energy recovery when further pressurization of condensed refrigerant from the compressor is performed to bring the fluid to a higher condensation state.

### BRIEF DESCRIPTION OF THE DRAWINGS

The invention will now be described in relation to the drawings, in which

FIG. 1 is a sectional partial view of an ejector of the prior art;

FIG. 2 is a schematic diagram of a simple refrigeration system, in an embodiment of the invention, and having a single phase ejector;

FIG. 3 is a schematic diagram of an ejector based heat pump system using a two-phase ejector as an expander, in another embodiment of the invention;

FIG. 4 is a schematic diagram of an ejector based heat pump system using a two-phase condensing ejector, in a further embodiment of the invention;

FIG. 5 is a schematic diagram of a hybrid heat pump system using an ejector externally activated to cool the condenser, in a further embodiment of the invention;

FIG. 6 is a schematic diagram of a hybrid heat pump system using an ejector activated either externally or internally to subcool the condenser, in a further embodiment of the invention;

FIG. 7 is a schematic diagram of an ejector based system, in a further embodiment of the invention;

FIG. 8 is a schematic diagram of an embodiment having a plurality of ejectors in series; and

FIG. 9 is a schematic diagram of a system having a plurality of ejectors in parallel.

### DETAILED DESCRIPTION OF THE DRAWINGS

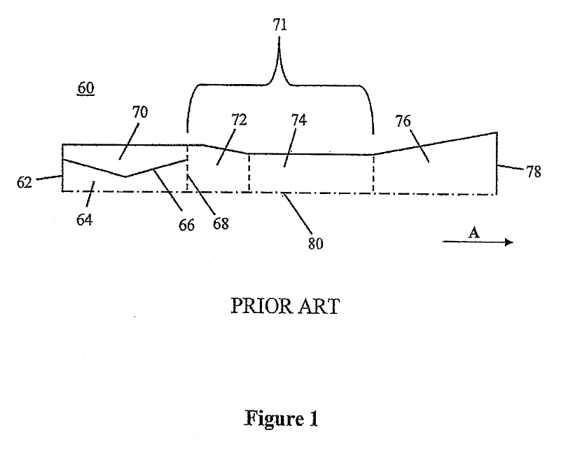

Referring first to FIG. 1, a known supersonic ejector 60, which is substantially symmetrical about its longitudinal axis 80, operates as follows.

A flow of vapour or liquid (not shown) is delivered to the ejector 60 as a primary, or motive, stream at high pressure, in the direction of arrow A, into the primary nozzle 64 at the inlet end 62. The nozzle is configured by wall 66 to provide a convergent-divergent path within which the input stream is expanded, producing a high velocity stream which passes through the nozzle outlet 68 towards the mixing chamber 71 which comprises a secondary nozzle section 72 and a constant cross-section zone 74. The configuration of the secondary nozzle section 72, which can be selected according to the intended end use and operating environment of the ejector 60, provides for deceleration of the supersonic flow, and enhancement of mixing of the streams, before they pass together into the constant cross-section zone 74, where shock waves occur, as discussed further below. Alternatively, for some situations the secondary nozzle section 72 may be omitted.

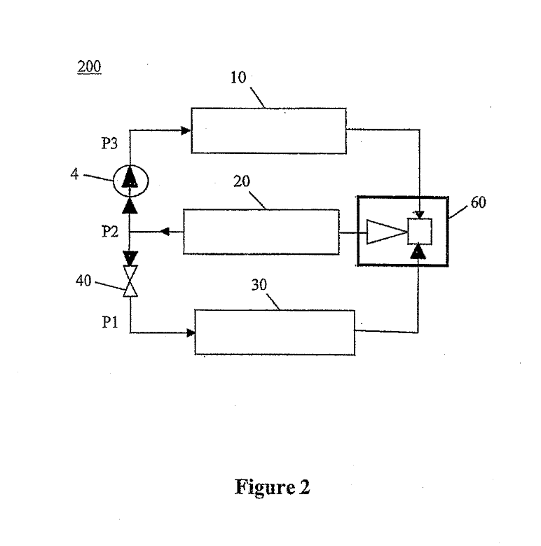

The flow of the primary stream at high pressure draws in a low pressure secondary stream (not shown), for example refrigerant from an evaporator (such as evaporator 30 shown in FIG. 2). The primary and secondary vapour streams merge in the mixing chamber 71 and undergo a mixing and compression process along the ejector 60, passing from the mixing chamber 71 to the diffuser 76, to exit at the outlet end 78.

The further performance and effect of the merged primary and secondary streams in relation to the invention is discussed further below in the context of the other features of embodiments of the invention.

Referring now to FIG. 2, in conjunction with FIG. 1 in relation to the features of the ejector 60, FIG. 2 illustrates the principle of operation of a refrigeration, cooling or heat pump system 200, based on a single phase, vapour-vapour ejector 60, the system 200 having the same components of a typical conventional vapour compression system, except that it does not include the typical compressor, but instead includes an ejector 60, a pump 4 and a generator 10. The generator is provided with heat from a suitable heat source, preferably a low temperature energy source such as waste heat, and supplies vapour at a high pressure (P3) to the primary inlet 62 of the ejector 60. This motive flow is accelerated in the primary nozzle 64 where it reaches supersonic velocity, creating a depression at the nozzle outlet 68, drawing in the secondary flow coming from the evaporator 30 at a lower pressure (P1). Both flows enter in contact before reaching the constant cross-section zone 74 of the mixing chamber 71, where the two velocities equalize at a constant pressure and a series of shock waves occur, accompanied by a significant pressure rise, while the velocity decreases to become subsonic, as the flow enters the diffuser 76, which further slows down the flow, allows the conversion of the remaining velocity into static pressure and the mixed flow reaches the intermediate pressure (P2), which is the pressure of the condenser 20. After condensation, part of the flow is expanded to the pressure (P1) at the evaporator 30 while the remaining flow is pumped back to the generator 10.

The combined stream exiting the ejector 60 liquefies by rejecting heat in the condenser 20. A portion of the condensate is directed through an expansion device 40 to the evaporator 30, producing a refrigeration effect. The remaining liquid is pumped back to the generator 10.

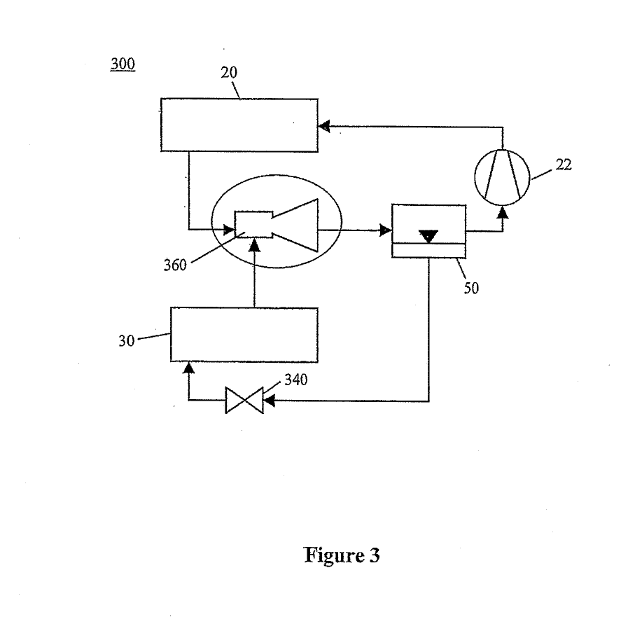

Referring now to FIG. 3, this shows a two-phase ejector 360 driven by high temperature and pressure condensate which is used to draw low pressure vapour refrigerant from the evaporator 30 and reject it to a medium pressure and temperature in the separator 50. The ejector 360 is structured in general in the manner shown in FIG. 1 relating to ejector 60, and is used in this case as an expander in replacement of the expansion device 40 of FIG. 2 to recover the compressor work usually lost by throttling, resulting in an advantageous corresponding increase in the coefficient of performance (COP) of the system.

The operation mechanisms of two-phase ejector 360 are similar in principle to a single phase ejector 60 except that the primary fluid (high pressure) is liquid and the secondary fluid (low pressure) is vapour. The ejector 360 is installed at the outlet of the condenser 20. The motive fluid (liquid from the condenser 20) enters into the nozzle 64 at a relatively high pressure. Reduction of the pressure of the liquid in the nozzle 64 provides the potential energy for conversion to kinetic energy of the liquid. The driving flow entrains vapour out of the evaporator 30. The liquid and vapour phases mix in the mixing chamber 71 and leave this latter after a recovery of pressure in the diffuser. As a result, a two-phase mixture of intermediate pressure is obtained. The vapour phase is then separated from the mixture and fed into the compressor 22, while the liquid phase is directed via an expansion device, shown as expansion valve 340, to the inlet (not shown) of the evaporator 30. In this process the throttling losses in the refrigeration or cooling cycle are reduced since the expansion valve 340 works across a small pressure differential between the evaporator 30 and the separator 50 (intermediate pressure) with more refrigeration or cooling capacity available. At the same time, the compressor 22 also works with a reduced pressure differential between the condenser 20 and the separator 50, resulting in better compressor performance. In short, the appropriate installation configuration improves the COP by raising the compression suction pressure to a level higher than that in the evaporator 30 and consequently, reducing the load on the compressor 22 and motor (not shown). The advantage of working at higher suction pressure on the intake (not shown) of the compressor 22 is a reduced compression ratio, consequent increased cycle efficiency and a longer compressor lifespan. Expected performance improvement over a conventional cycle working in the same conditions is between 10% and 15% in terms of the COP.

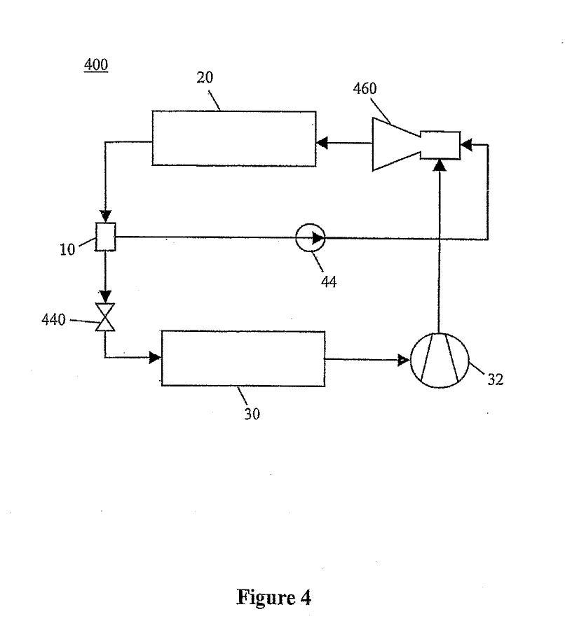

A further embodiment is shown in FIG. 4, which shows a configuration using a condensing ejector 460 for heating applications. This case also results in a reduction of the work of the compressor 32, and therefore in an increase of the system capacity, its performance and its rejection temperature. The COP improvement over an ordinary heat pump can be as high as 25%, depending on the operating conditions. The two-phase ejector 460 is still driven by the condensate, in the same way as in the embodiment shown in FIG. 3, except that prior to being sent to the ejector 460, the condensate pressure is raised through a booster pump 44 so that the ejector 360 is enabled to draw vapour refrigerant from the compressor 32. Part of the flow from the condenser 20 is separated at generator 10 to pass through expansion valve 440 to evaporator 30. The cycle of this embodiment can be used in heat pump applications, including absorption heat pumps. Expected COP improvement over an ordinary heat pump can be as high as 30%, depending on the operating conditions.

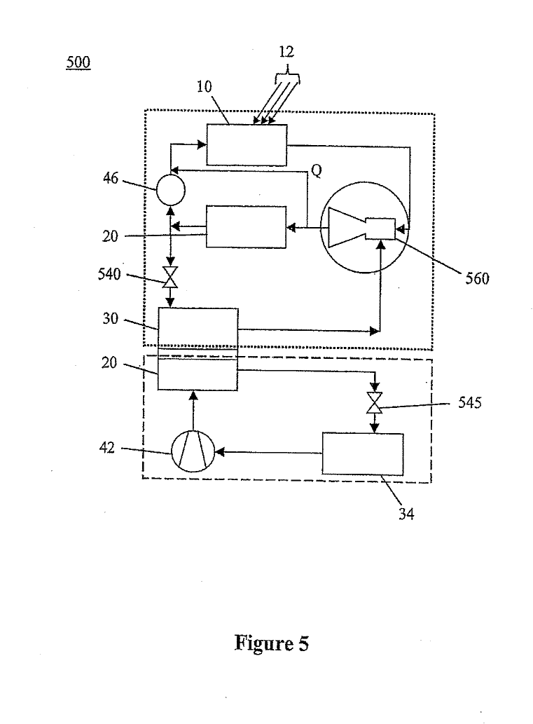

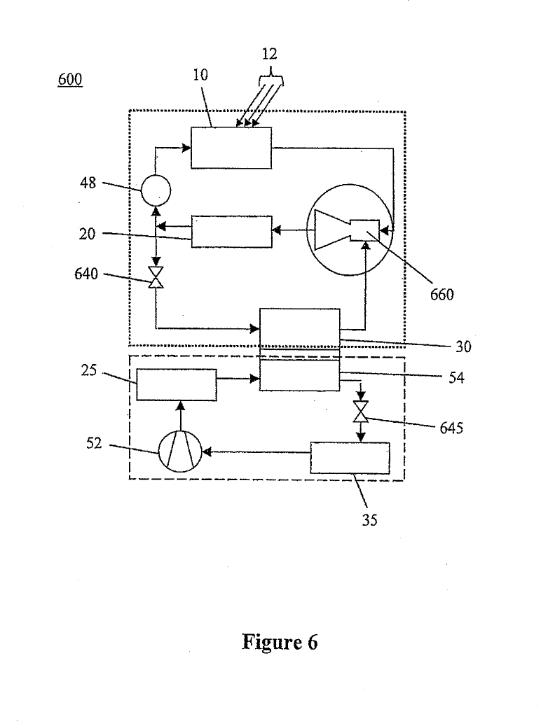

Referring now to FIGS. 5 and 6, two further embodiments of ejector heat pump applications are shown in cascade with a classical system. In the first case, shown in FIG. 5 as system 500, the ejector 560 is activated by a heat source and is used to cool the heat pump condenser 20. Part of the flow from condenser 20 passes through pump 46 to generator 10, and the remainder passes through expansion valve 540 to first evaporator 30. Flow from lower condenser 20 passes through expansion valve 545 to lower evaporator 34, and thence to compressor 42. This configuration can advantageously replace a more complex two-stage compression system. The COP improvement is up to 40%, resulting from the lowering of the condenser temperature, and thus improving the performance of the classical mechanical system.

FIG. 5 also shows a further option for the systems of the invention. As the stream leaving ejector 560 is generally superheated, part of the stream can be separated and delivered along the path indicated as Q to join the flow path from pump 46 to generator 10, to use excess heat within the system to provide a preheating effect to the stream entering generator 10.

In the second case, shown in FIG. 6 as system 600, the loop of the ejector 660 is used to sub-cool the condenser 20. Other elements of this embodiment correspond substantially to those of the embodiment shown in FIG. 5. Thus, part of the flow from condenser 20 passes through pump 48 to generator 10, and the remainder passes through expansion valve 640 to first evaporator 30. Flow from lower subcooler 54 passes through expansion valve 645 to lower evaporator 35, and thence via compressor 52 to condenser 25. Expected COP improvement in this case ranges from 5% to 20%. By subcooling the condensate, there is a reduction in flash evaporation through expansion valve 645 and therefore more liquid is available for the evaporator, thereby improving its capacity. The ejector system is activated with an external or an internal heat source. Heat for activation may come from industrial processes, solar collectors, distributed generation systems or from compressor superheat.

In each of systems 500, 600 shown respectively in FIGS. 5 and 6, ejectors 560, 660 respectively work in single phase vapour-vapour mode (one-phase flow), and helps increase the heat pump system capacity and performance. These configurations are equally suitable for absorption heat pumps, for heating, cooling or refrigeration applications.

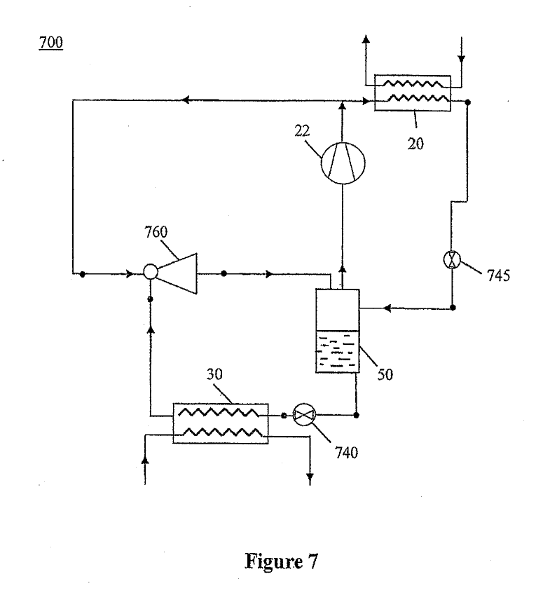

Referring now to FIG. 7, a further embodiment of the invention is shown as system 700, in which part of the stream which leaves compressor 22 passes to ejector 760, while the other part is condensed in condenser 20 and expanded by expansion valve 745 to the intermediate conditions of separator 50. Liquid from separator 50 expands through expansion valve 740 to the conditions of evaporator 30, at the exit of which the vapour is drawn by ejector 760. This system allows for compressor 22 to run with a low compression ratio, and ejector 760 to operate with a low temperature lift, enabling the system to provide low temperatures with an improved overall performance, i.e. with a higher COP than for example the system of FIG. 2.

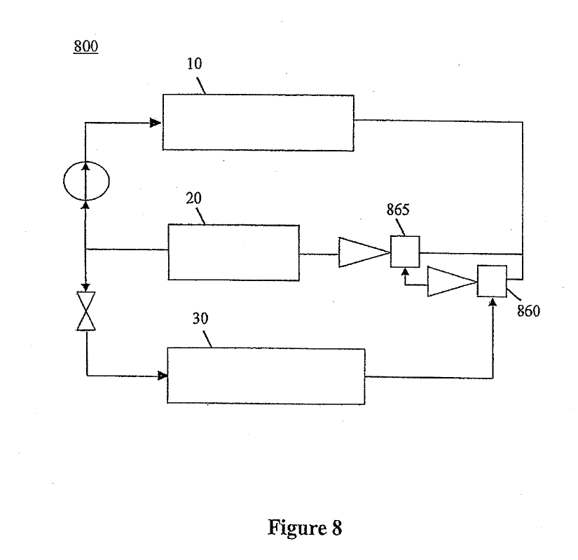

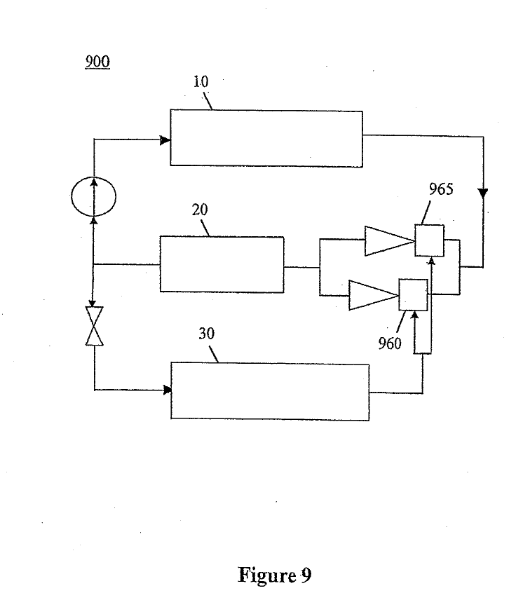

Referring now to FIGS. 8 and 9, these figures illustrate schematically the use of a plurality of ejectors. These are illustrated in a system similar to that shown in FIG. 2, but as noted above, in each of the embodiments of the invention, the single ejector shown in FIGS. 2 to 7 can be replaced advantageously in many situations by a plurality of ejectors, installed in series or in parallel, or some in series and others in parallel, their configuration and internal geometry being variously selected so as to maximize the combinations of characteristics available to the specific system.

In the configuration 800 shown in FIG. 8, the ejectors 860, 865 are provided in series, and are fed with the same source of primary flow from the generator 10, but the secondary flow of the first ejector 860 comes from the evaporator 30. The total flow leaving this first ejector 860 with a first compression step is fed as the secondary flow of the second ejector 865 which compresses it further before the condenser 20.

In the configuration 900 shown in FIG. 9, the ejectors 960, 965 are provided in parallel, and are each activated by the same primary fluid from the generator 10, and both draw simulataneously from the evaporator 30. In this case there is a single compression step, but the capacity of the set up is increased.

Further, for each of the embodiments of the invention, the energy provided to the generator 10 from outside the system can be from any suitable source, shown as source 12 in FIGS. 5 and 6, but is preferably provided from either waste heat from any available system, or from solar energy.

The internal geometry of an ejector plays an important role in its efficient operation, and depends on the relative positions of internal elements which are adjusted on a case by case basis and are part of performance enhancement strategy.

With the appropriate selection of refrigerants, geometry and operational procedure, ejector performance can at least approach that of absorption machines which are the most mature thermally operated machines. Known working fluids such as R-134a, R-152, R-717, R-245fa, R290, R600, carbon dioxide, trans-butene or any other suitable fluid can be used depending on the particular applications, based on criteria including operating conditions and performance.

Ejector technology represents a higher potential for success than the absorption equivalent due to its simplicity, low global cost and reduced size. When correctly inserted in an energy management loop, such a component can provide a net improvement in heating or cooling systems (in the order of 10 to 40%). New application opportunities of this technology exist in buildings and industry and can be extended to other sectors such as transport.

Despite the apparent simplicity of ejector operation, the hydrodynamic processes and the internal non-equilibrium thermal state are complex. The selection of the configuration of the elements of the system, and the type and appropriate internal geometry for the ejector 60, i.e. its internal flow structure (shapes and relative positions) for maximal entrainment ratios, will depend on the intended end use application for the system. Pursuant to the methods of the invention, this determination is made according to numerical-experimental integration in order to minimise thermal hydraulic irreversible losses due to velocity and temperature differences within the hot and cold streams, the mixing process, shock formation and recirculation zones.

As noted above, the systems of the invention can advantageously be used in numerous fields of application, particularly in the following cases.

Firstly, the systems are particularly suitable for recovery of thermal waste or any other activation source at low temperature, i.e. between about 60° C. and 200° C. This temperature range includes thermal waste from boilers in industrial processes, solar energy, energy from biomass or any other heat source in the same range. Single phase ejectors are particularly well suited to this type of application, either to produce a refrigeration/air-conditioning effect, in which case a free refrigeration effect can be produced with a basic ejector system such as shown in FIG. 2, or to improve the performance of a mechanical cycle by cooling the condenser or sub-cooling condensate at the condenser exit, as shown in FIGS. 5 and 6. Sub-cooling ejectors can also be used to improve performance of several processes generally encountered in the chemical, petrochemical and pulp and paper industries.

Secondly, the systems can advantageously be used for the replacement of expansion devices within a refrigeration, cooling or heat pump cycle. In such cases, the ejector contributes to an efficient compressor operation with a reduced compression ratio. The expansion valve feeding the evaporator is thus submitted to a smaller pressure difference and improves capacity. In this case the ejector is fed by high pressure condensate and draws low pressure vapour from the evaporator. The ejector operates in two-phase mode within specific conditions, such as shown in FIGS. 3 and 4.

In general, the cycle selection in which the ejector is integrated is of great importance. The ejector type depends on the considered system and its conditions such as temperature, pressure, flow rates, fluid type and the process. Depending on the context, either type of ejector (single-phase or two-phase) may be used. Further, the ejector location within the cycle and its interaction with other surrounding components, are important factors.

Additional factors affecting the selection of appropriate systems include the internal geometry, as noted above, in order to maximize performance while allowing a degree of capacity variation; selection of appropriate working fluid (including mixtures of refrigerants) according to capacity and compression ratio; thermophysical properties allowing the system to operate closer to saturation conditions (minimal superheat) and providing high compression ratios while minimizing condensation risks during the expansion of the primary stream of single phase ejectors; and the use of batteries of ejectors, having various characteristics.

Within a selected cycle, the ejector type, its location and the fluid used will be the result of a compromise involving factors including temperature levels (hot and cold) at inlets/outlets; internal heat recovery allowing performance increases within the cycle; selection of appropriate heat exchangers; configurations favouring natural circulation and/or reduction in pressure losses; and taking advantage of temperature glides, i.e. the range of temperatures at which phase changes (evaporation or condensation) occur for refrigerant mixtures, for efficient heat transfer within the cycle.

Ejectors offer a unique opportunity to make use of waste, renewable or excess heat to provide heat upgrading or cooling-refrigeration, or to improve the efficiency of heating and cooling systems, for all types of buildings. The systems of the invention are thus particularly well suited to use solar heat or excess heat reclaimed from distributed generation systems for tri-generation (power, heating and cooling) applications, and are thus of importance in waste heat upgrading and for increasing cooling and refrigeration system performance in industrial applications. Ejectors may also be integrated in hybrid ejecto-compression or ejecto-absorption cycles to increase the system performance. In this case they may be use in their single phase or two-phase form. As noted above, depending on the system selected, expected improvements of the COP for various heating and cooling systems with integrated ejectors are in the range of 5% to 50%.

1. A pumping system for temperature management comprising
(i) generator means, constructed and arranged to be operatively connected to an energy source;
(ii) condenser means;
(iii) evaporator means; and
(iv) pressure means comprising at least one supersonic ejector constructed and arranged to receive and provide flow paths for an input primary flow and an input secondary flow, the input primary flow being selected from a gaseous flow and a liquid flow.

2-32. (canceled)

33. A system according to claim 1, wherein the temperature management is selected from at least one of heating, refrigeration, cooling and air-conditioning.

34. A system according to claim 1, wherein the energy source comprises an energy source selected from at least one of a waste heat delivery means and a solar heat delivery means.

35. A system according to claim 1, further comprising separator means having an inlet means operatively connected to the pressure means and an outlet means operatively connected to the evaporator means.

36. A system according to claim 35, wherein the separator means comprises a second inlet means and a second outlet means each operatively connected to the condenser means.

37. A system according to claim 1, comprising a plurality of supersonic static ejectors.

38. A system according to claim 37, wherein the plurality of supersonic static ejectors comprises at least two supersonic static ejectors which are operationally located in series.

39. A system according to claim 37, wherein the plurality of supersonic static ejectors comprises at least two supersonic static ejectors which are operationally located in parallel.

40. A system according to claim 37, wherein at least one of the plurality of supersonic static ejectors has a configuration and a capacity which differs from a configuration and a capacity of at least one other of the supersonic static ejectors.

41. A system according to claim 40, further comprising a control means to selectively activate and deactivate individual ones of the supersonic static ejectors in response to determinations of operating conditions within the system.

42. A system according to claim 1, wherein each of the at least one supersonic static ejector further comprises internal adjustment means.

43. A system according to claim 42, wherein the internal adjustment means comprises means for adjusting at least one parameter selected from the configuration and dimensions of the flow paths provided for each of the input primary flow and the input secondary flow.

44. A method of temperature management for a structure, the method comprising the steps of
(a) providing energy source means, condenser means and evaporator means, and generator means for operative connection to the energy source means, the condenser means and the evaporator means;
(b) selecting a pressure means comprising at least one supersonic static ejector, each ejector having an internal configuration constructed and arranged to receive an input primary flow and an input secondary flow;
(c) providing an operative connection between the pressure means, the condenser means and the evaporator means to provide a flow path for a temperature management fluid;
(d) selecting a temperature management fluid and delivering a supply of the selected temperature management fluid to the flow path;
(e) providing an operative connection between the generator means and the energy source means and using energy from the energy source means to activate and operate the generator to move the supply of temperature management fluid along the flow path to selectively regulate temperatures at selected locations associated with the structure;
(f) selectively monitoring temperatures at the selected locations to obtain determined temperature values; and
(g) selectively adjusting the configuration and operational parameters of the pressure means in response to the determined temperature values and operating conditions.

45. A method according to claim 44, wherein each of the at least one supersonic static ejector comprises internal adjustment means, and the adjusting in step (g) further comprises operating the internal adjustment means to selectively adjust the internal configuration of selected ones of the at least one supersonic static ejector.

46. A method according to claim 44, wherein each of the at least one supersonic static ejector is constructed and arranged to receive an input primary flow selected from a gaseous flow and a liquid flow.

47. A method according to claim 44, wherein step (b) comprises selecting a plurality of supersonic static ejectors.

48. A method according to claim 47, wherein the plurality of supersonic static ejectors comprises at least two supersonic static ejectors which are operationally located in series.

49. A method according to claim 47, wherein the plurality of supersonic static ejectors comprises at least two supersonic static ejectors which are operationally located in parallel.

50. A method according to claim 47, wherein at least one of the plurality of supersonic static ejectors has a configuration and a capacity which differs from a configuration and a capacity of at least one other of the plurality of supersonic static ejectors.

51. A method according to claim 50, wherein step (b) further comprises providing a control means operatively connected to each of the plurality of supersonic static ejectors, and step (g) comprises selectively activating and deactivating individual ones of the supersonic static ejectors.

52. A method according to claim 44, wherein the temperature management fluid is a refrigerant.

53. A method according to claim 52, wherein the refrigerant is selected from R-123, R-134a, R-152, R-717, R-245fa, R290, R600, carbon dioxide and trans-butene.

54. A method according to claim 44, wherein the energy source means is constructed and arranged to deliver energy selected from at least one of waste heat and solar heat.

55. A method according to claim 44, wherein the monitoring in step (f) is performed in a manner selected from periodically and continuously.

56. A method according to claim 44, wherein the adjusting in step (g) comprises adjusting a configuration of the flow path in relation to each supersonic static ejector.

57. A method according to claim 44, wherein the adjusting in step (g) comprises adjusting operational parameters selected from at least one of a rate of supply of energy to the energy source means, and location and configuration of at least one of the condenser means, the evaporator means, and the generator means.

58. A computer readable medium having recorded thereon computer readable instructions for performing at least one step of the method of claim 44.

59. A computer readable medium according to claim 58, wherein the at least one step comprises selectively monitoring temperatures at the selected locations to obtain determined temperature values; and selectively adjusting the configuration and operational parameters of the pressure means in response to the determined temperature values and operating conditions.

60. A computer readable medium according to claim 58, wherein the at least one step comprises selectively adjusting the internal configuration of selected ones of the at least one supersonic static ejector.

61. A computer readable medium according to claim 58, wherein the at least one step comprises selectively activating and deactivating individual ones of a plurality of supersonic static ejectors.

62. A computer readable medium according to claim 58, wherein the at least one step comprises adjusting a configuration of the flow path in relation to each supersonic static ejector.

63. A computer readable medium according to claim 58, wherein the at least one step comprises adjusting operational parameters selected from at least one of a rate of supply of energy to the energy source means, and location and configuration of at least one of the condenser means, the evaporator means, and the generator means.
